(19) United States
(12) Patent Application Publication
(10) Pub. No.: US 2026/0089762 A1
(43) Pub. Date: Mar. 26, 2026

(54) STATE-BASED CONNECTED MODE RANDOM ACCESS FOR WIRELESS COMMUNICATIONS

(71) Applicant: QUALCOMM Incorporated, San Diego, CA (US)

(72) Inventors: Chiranjib SAHA, Lakeside, CA (US); Ayan SENGUPTA, San Diego, CA (US); Alberto RICO ALVARINO, San Diego, CA (US); Xiao Feng WANG, San Diego, CA (US)

(21) Appl. No.: 18/896,651

(22) Filed: Sep. 25, 2024

(51) Int. Cl. H04W 74/0833; H04W 74/00; H04W 76/10; H04W 84/06

(52) U.S. Cl. CPC H04W 74/0833; H04W 74/006; H04W 76/10; H04W 84/06

(57) ABSTRACT

Methods, systems, and devices for wireless communications are described. A connected mode user equipment (UE) may determine to perform a random access (RACH) procedure with a non-terrestrial network (NTN) entity based on an occurrence of a RACH triggering event using a RACH configuration that is based on a state of the UE with respect to a global navigation satellite system (GNSS). In some examples, the UE may receive a GNSS RACH configuration, a GNSS-less RACH configuration, or both, corresponding to a RACH triggering event. In some cases, if the RACH configuration received by the UE is not associated with a same state in which the UE is in, the UE may utilize one or more parameters from RACH configuration, one or more parameters from a common RACH configuration, or both, to transmit the RACH signaling. The received RACH configurations may also be based on a capability report of the UE.

### FIELD OF TECHNOLOGY

The following relates to wireless communications, including state-based connected mode random access for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include entering a connected mode associated with a non-terrestrial network (NTN) entity based on being within a cell served by the NTN entity, determining to perform a random access (RACH) procedure with the NTN entity while in the connected mode based on an occurrence of a RACH triggering event associated with the connected mode, and transmitting, via the transceiver and as part of the RACH procedure, a RACH signal based on a RACH configuration and a state of the UE with respect to a navigation satellite system (e.g., global navigation satellite system (GNSS)).

A UE for wireless communication is described. The UE may include one or more memories storing processor executable code, a transceiver, and one or more processors coupled with the one or more memories and the transceiver. The one or more processors may individually or collectively be operable to execute the code to cause the UE to enter a connected mode associated with a NTN entity based on being within a cell served by the NTN entity, determine to perform a RACH procedure with the NTN entity while in the connected mode based on an occurrence of a RACH triggering event associated with the connected mode, and transmit, via the transceiver and as part of the RACH procedure, a RACH signal based on a RACH configuration and a state of the UE with respect to a navigation satellite system.

Another UE for wireless communication is described. The UE may include means for entering a connected mode associated with a NTN entity based on being within a cell served by the NTN entity, means for determining to perform a RACH procedure with the NTN entity while in the connected mode based on an occurrence of a RACH triggering event associated with the connected mode, and means for transmitting, via the transceiver and as part of the RACH procedure, a RACH signal based on a RACH configuration and a state of the UE with respect to a navigation satellite system.

A non-transitory computer-readable medium storing code for wireless communication is described. The code may include instructions executable by one or more processors to enter a connected mode associated with a NTN entity based on being within a cell served by the NTN entity, determine to perform a RACH procedure with the NTN entity while in the connected mode based on an occurrence of a RACH triggering event associated with the connected mode, and transmit, via the transceiver and as part of the RACH procedure, a RACH signal based on a RACH configuration and a state of the UE with respect to a navigation satellite system.

In some examples of the method, UEs, and non-transitory computer-readable medium described herein, the state of the UE includes whether the UE may be able to obtain its location using the navigation satellite system, whether the UE may be capable of using the navigation satellite system, or both.

Some examples of the method, UEs, and non-transitory computer-readable medium described herein may further include operations, features, means, or instructions for receiving, via the transceiver, control signaling indicating a set of multiple RACH configurations that corresponds to the RACH triggering event, where the set of multiple RACH configurations includes a first RACH configuration for UEs in a first state with respect to the navigation satellite system and a second RACH configuration for UEs in a second state with respect to the navigation satellite system.

Some examples of the method, UEs, and non-transitory computer-readable medium described herein may further include operations, features, means, or instructions for selecting the RACH configuration from among the set of multiple RACH configurations based on the state of the UE with respect to the navigation satellite system.

In some examples of the method, UEs, and non-transitory computer-readable medium described herein, the state of the UE with respect to the navigation satellite system includes the UE being unable to obtain its location using the navigation satellite system and the method, apparatuses, and non-transitory computer-readable medium may include further operations, features, means, or instructions for receiving, via the transceiver, control signaling indicating a single RACH configuration that may be for UEs in a first state with respect to the navigation satellite system, the first state including the UE being unable to obtain its location using the navigation satellite system or being incapable of using the navigation satellite system, where the RACH configuration includes the single RACH configuration.

In some examples of the method, UEs, and non-transitory computer-readable medium described herein, the state of the UE with respect to the navigation satellite system includes the UE being unable to obtain its location using the navigation satellite system and the method, apparatuses, and non-transitory computer-readable medium may include further operations, features, means, or instructions for receiving, via the transceiver, first control signaling indicating an uplink timing advance, a frequency adjustment, or both, associated with the RACH procedure and receiving, via the transceiver, second control signaling indicating the RACH configuration, where the RACH configuration includes RACH resources for UEs that may be able to obtain their location using the navigation satellite system or capable of using the navigation satellite system, and where the RACH signal may be transmitted based on the RACH resources and one or both of the uplink timing advance and the frequency adjustment.

In some examples of the method, UEs, and non-transitory computer-readable medium described herein, at least one of the uplink timing advance or the frequency adjustment may be common for one or more UEs within the cell.

In some examples of the method, UEs, and non-transitory computer-readable medium described herein, at least one of the uplink timing advance or the frequency adjustment may be dedicated to the UE.

Some examples of the method, UEs, and non-transitory computer-readable medium described herein may further include operations, features, means, or instructions for transmitting, via the transceiver, a capability report indicating that the UE supports RACH configuration for UEs in a first state with respect to the navigation satellite system, that the UE supports RACH configuration for UEs in a second state with respect to the navigation satellite system, or both and receiving, via the transceiver, control signaling indicating one or more RACH configurations based on the capability report, the one or more RACH configurations including the RACH configuration.

Some examples of the method, UEs, and non-transitory computer-readable medium described herein may further include operations, features, means, or instructions for receiving, via the transceiver, one or more common RACH configurations that may be common for one or more UEs within the cell, the RACH configuration included in the one or more common RACH configurations and identifying RACH resources associated with the RACH configuration based on the state of the UE with respect to the navigation satellite system.

In some examples of the method, UEs, and non-transitory computer-readable medium described herein, the one or more common RACH configurations indicate a common timing advance, a common frequency adjustment, or both, associated with the RACH procedure, the state of the UE with respect to the navigation satellite system includes the UE being unable to obtain its location using the navigation satellite system, being incapable of using the navigation satellite system, or both, and the RACH signal may be transmitted based on the common timing advance, the common frequency adjustment, or both.

In some examples of the method, UEs, and non-transitory computer-readable medium described herein, the state of the UE with respect to the navigation satellite system includes the UE being able to obtain its location using the navigation satellite system and the method, apparatuses, and non-transitory computer-readable medium may include further operations, features, means, or instructions for performing one or more measurements associated with the navigation satellite system to derive a UE-specific timing advance associated with the RACH procedure, a UE-specific frequency adjustment associated with the RACH procedure, or both based on the state of the UE with respect to the navigation satellite system, where the RACH signal may be transmitted based on one or both of the UE-specific timing advance and the UE-specific frequency adjustment.

In some examples of the method, UEs, and non-transitory computer-readable medium described herein, the state of the UE with respect to the navigation satellite system includes the UE being unable to obtain its location using the navigation satellite system and the method, apparatuses, and non-transitory computer-readable medium may include further operations, features, means, or instructions for receiving, via the transceiver, control signaling indicating a single second RACH configuration corresponding to the RACH triggering event and deriving the RACH configuration from another RACH configuration that may be different from the single second RACH configuration based on the state of the UE and one or more conditions associated with the single second RACH configuration.

In some examples of the method, UEs, and non-transitory computer-readable medium described herein, the occurrence of the RACH triggering event may include operations, features, means, or instructions for receiving, based on the state of the UE with respect to the navigation satellite system and via the transceiver, control signaling requesting that the UE perform the RACH procedure, the control signaling further indicating a second state with respect to the navigation satellite system, the second state the same as or different than the state of the UE with respect to the navigation satellite system, where the RACH configuration used for transmitting the RACH signal may be based on the second state indicated by the control signaling.

In some examples of the method, UEs, and non-transitory computer-readable medium described herein, the control signaling requests that the UE performs the RACH procedure according to the RACH configuration for UEs that may be unable to obtain their location using the navigation satellite system or may be incapable of using the navigation satellite system and the method, apparatuses, and non-transitory computer-readable medium may include further operations, features, means, or instructions for deriving a timing advance of the RACH configuration used for transmitting the RACH signal, a frequency adjustment of the RACH configuration used for transmitting the RACH signal, or both from another RACH configuration that may be unassociated with the navigation satellite system.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports state-based connected mode random access for wireless communications in accordance with one or more aspects of the present disclosure.

FIG. 2 shows an example of a wireless communications system that supports state-based connected mode random access for wireless communications in accordance with one or more aspects of the present disclosure.

FIG. 3 shows an example of a process flow that supports state-based connected mode random access for wireless communications in accordance with one or more aspects of the present disclosure.

FIGS. 4 and 5 show block diagrams of devices that support state-based connected mode random access for wireless communications in accordance with one or more aspects of the present disclosure.

FIG. 6 shows a block diagram of a communications manager that supports state-based connected mode random access for wireless communications in accordance with one or more aspects of the present disclosure.

FIG. 7 shows a diagram of a system including a device that supports state-based connected mode random access for wireless communications in accordance with one or more aspects of the present disclosure.

FIG. 8 shows a flowchart illustrating methods that support state-based connected mode random access for wireless communications in accordance with one or more aspects of the present disclosure.

### DETAILED DESCRIPTION

In some wireless communications systems, a user equipment (UE) may establish a wireless connection (e.g., enter a connected mode) with a non-terrestrial network (NTN) entity (e.g., a satellite). After establishing the wireless connection, the UE may perform a random access procedure (e.g., random access channel (RACH) procedure) to improve communication with the network entity. For example, the UE may detect a random access triggering event (e.g., RACH triggering event), and may transmit random access signaling (e.g., RACH signaling, random access signals, RACH messages) to the NTN entity in response to the RACH triggering event.

In some examples, the UE may determine position information based on a global navigation satellite system (GNSS) (e.g., navigation satellite system, global positioning service (GPS)), and apply one or more offsets (e.g., a timing advance, a frequency adjustment) to the RACH signaling. For example, the NTN entity may be relatively far away from the UE, moving at a relatively high speed with respect to the UE, or both, and the one or more offsets may account for delays or Doppler effects encountered by the UE in communicating with the NTN entity. However, a state of the UE with respect to the GNSS may vary, where the state of the UE may indicate whether the UE is able to obtain its location using the GNSS (e.g., at a current moment, whether there are blockages or other obstacles stopping the UE from measuring signals from the GNSS), whether the UE is capable of using the GNSS (e.g., whether the UE has a capability to measure signals from or communicate with the GNSS), or both. A UE able to obtain its location using the GNSS, capable of using the GNSS, or both, may be in an GNSS state (e.g., a first state), and a UE that is not able to obtain its location using the GNSS, incapable of using the GNSS, or both, may be in an GNSS-less state (e.g., a second state).

Additionally, the UE may receive one or more common or dedicated RACH configurations (e.g., random access configurations) for performing the RACH procedure, which may indicate RACH resources (e.g., random access occasions (ROs) that indicate time and frequency resources, RACH cyclic prefixes or sequences), one or more offsets (e.g., timing advance, frequency adjustments), or any combination thereof. The RACH may be a transport layer channel. The physical random access channel (PRACH) may be a physical layer channel corresponding to the RACH, with RACH messages and RACH signaling conveyed via the RACH at the transport layer and via the PRACH at the physical layer. As used herein, a RACH configuration may refer to a set of configuration information that is applicable to the RACH, the PRACH, or both. For instance, in at least some examples, configurations related to the PRACH may be derived by a UE based on the RACH configuration, and hence a RACH configuration may specify the configuration of both the RACH and the PRACH. Different RACH configurations may be advantageous for UEs in the GNSS state as opposed to UEs in the GNSS-less state, but the received RACH configurations may not account for such differences in the state of a UE. Thus, techniques for improving a RACH configuration for a UE to perform a RACH procedure based on a state of the UE with respect to an GNSS may be beneficial.

According to techniques described herein, a UE may establish a connection (e.g., enter a connected mode) with an NTN entity, determine to perform a RACH procedure based on an occurrence of a RACH triggering event, and transmit a RACH message using a RACH configuration that is based on a state of the UE with respect to an GNSS. The UE may receive one or more RACH configurations, which may be UE-dedicated or common for a cell served by the NTN entity, and may include one or more of legacy RACH configurations (e.g., unassociated with the GNSS, assume that all UEs are in a GNSS state), GNSS RACH configurations (e.g., for UEs in the GNSS state), or GNSS-less RACH configurations (e.g., for UEs in the GNSS-less state). For example, the UE may receive a UE-dedicated GNSS RACH configuration and a UE-dedicated GNSS-less RACH configuration for (e.g., corresponding to) each of one or more RACH triggering events associated with the connected mode, and may select a RACH configuration based on the state of the UE. Additionally, or alternatively, the UE may receive a single UE-dedicated RACH configuration for a RACH triggering event. If the single UE-dedicated RACH configuration is associated with a state that is different from a state in which the UE is, the UE may utilize one or more parameters from the single UE-dedicated RACH configuration, one or more parameters from a common RACH configuration (e.g., common for UEs within a cell of the NTN entity). one or more parameters determined based on GNSS measurements (e.g., if the UE is in a GNSS state), or any combination thereof, to perform the RACH procedure. For example, the UE may utilize RACH resources (e.g., an RO and a cyclic prefix) from the UE-dedicated RACH configuration, and may use one or more offsets from a common RACH configuration. Additionally, if the UE is in the GNSS mode, the UE may perform one or more measurements of GNSS signaling from a GNSS entity to determine one or more offsets for the RACH procedure.

In some cases, the NTN entity may not configure the UE with a UE-dedicated RACH configuration for a RACH triggering event, and the UE may derive a RACH configuration for the RACH triggering event from one or more common RACH configuration based on the state of the UE with respect to the GNSS. Additionally, or alternatively, the UE may transmit a capability report to the NTN entity associated with the GNSS, and the NTN entity may configure the UE with one or more UE-dedicated RACH configurations based on the capability report. In some examples, the NTN entity may transmit a physical downlink control channel (PDCCH)-order to the UE requesting the UE to perform a RACH procedure, and the PDCCH-order may indicate in the request if the UE is to perform the RACH procedure using a GNSS RACH configuration or a GNSS-less RACH configuration.

Aspects of the disclosure are initially described in the context of wireless communications systems. Aspects of the disclosure are also described with respect to process flows. Aspects of the disclosure are further illustrated by and described with reference to apparatus diagrams, system diagrams, and flowcharts that relate to state-based connected mode random access for wireless communications.

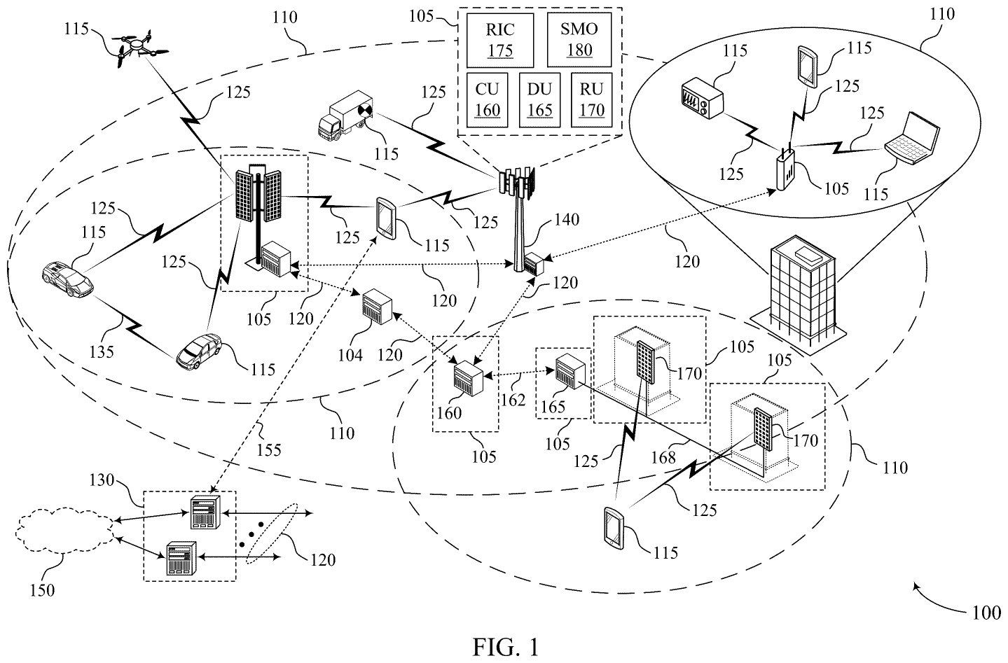

FIG. 1 shows an example of a wireless communications system 100 that supports state-based connected mode random access for wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples described herein, the network entities 105 my include one or more NTN entities of an NTN, where the NTN entities may be mobile or fixed satellites (e.g., geostationary orbit (GSO) or non-GSO (NGSO) satellites) that perform one or more same functions as the network entities 105. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support state-based connected mode random access for wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 (e.g., including an NTN entity) may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., an NTN entity, a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

According to techniques described herein, a UE 115 may enter a connected mode with an NTN entity, determine to perform a RACH procedure based on an occurrence of a RACH triggering event, and transmit a RACH message using a RACH configuration that is based on a state of the UE 115 with respect to a GNSS. In some aspects, the GNSS may be a network of satellites that provide global navigation signaling to allow a device, such as a UE 115, to determine position information associated with the device relative to the Earth.

The UE 115 may receive one or more RACH configurations from the NTN entity (e.g., or another network entity 105), where the one or more RACH configuration may be UE-dedicated or common for a cell served by the NTN entity, and may include one or more of legacy RACH configurations (e.g., unassociated with the GNSS, assume that all UEs are in a GNSS state), GNSS RACH configurations (e.g., for UEs 115 in the GNSS state), or GNSS-less RACH configurations (e.g., for UEs 115 in the GNSS-less state). In one example, the UE 115 may receive a UE-dedicated GNSS RACH configuration and a UE-dedicated GNSS-less RACH configuration for (e.g., corresponding to) each of one or more RACH triggering events associated with the connected mode, and may select a RACH configuration to use based on the state of the UE 115. Additionally, or alternatively, the UE 115 may receive a single UE-dedicated RACH configuration for a RACH triggering event. If the single UE-dedicated RACH configuration is associated with a state that is different from the state in which the UE 115 is, the UE 115 may utilize one or more parameters from the single UE-dedicated RACH configuration, one or more parameters from a common RACH configuration, one or more parameters determined from GNSS measurements, or any combination thereof, to perform the RACH procedure. For example, the UE may utilize RACH resources (e.g., an RO and a cyclic prefix) from the UE-dedicated RACH configuration, and may use one or more offsets from a common RACH configuration. Additionally, if the UE is in the GNSS mode, the UE may perform one or more measurements of GNSS signaling from a GNSS entity to determine one or more offsets for the RACH procedure.

In some cases, the NTN entity may not configure the UE 115 with any UE-dedicated RACH configurations for a RACH triggering event, and the UE 115 may derive a RACH configuration for the RACH triggering event from one or more common RACH configuration based on the state of the UE 115 with respect to the GNSS. Additionally, or alternatively, the UE 115 may transmit a capability report to the NTN entity associated with the GNSS, and the NTN entity may configure the UE 115 with one or more UE-dedicated RACH configurations based on the capability report. In some examples, the NTN entity may transmit a physical downlink control channel (PDCCH)-order to the UE 115 requesting the UE 115 to perform a RACH procedure, and the PDCCH-order may indicate in the request if the UE 115 is to perform the RACH procedure using a GNSS RACH configuration or a GNSS-less RACH configuration.

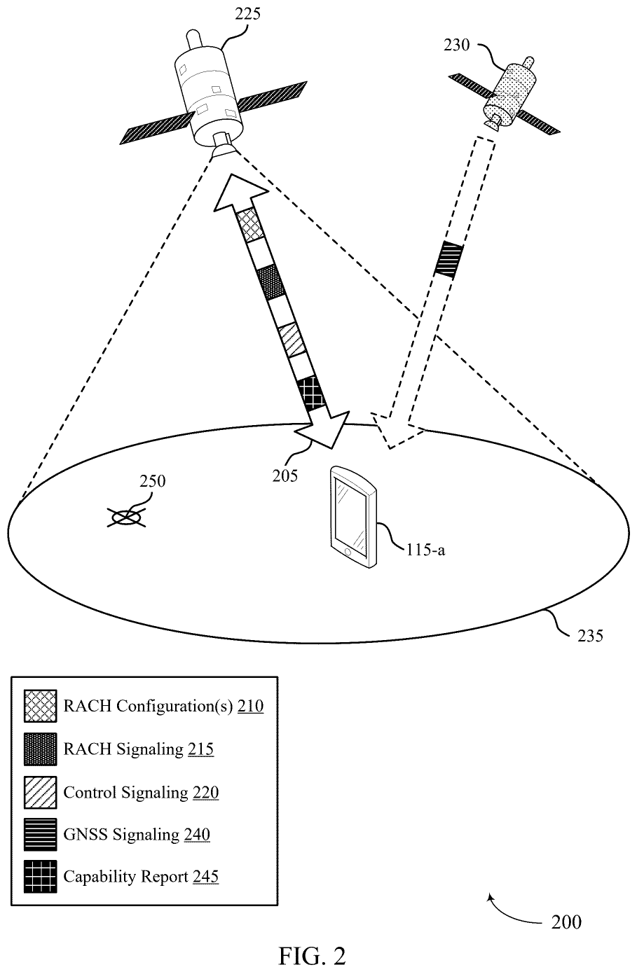

FIG. 2 shows an example of a wireless communications system 200 that supports state-based connected mode random access for wireless communications in accordance with one or more aspects of the present disclosure. In some cases, aspects of the wireless communications system 200 may implement or be implemented by aspects of FIG. 1. For example, the wireless communications system 200 may include an NTN entity 225 (e.g., an example of a network entity 105, including an NTN entity, described with respect to FIG. 1), a UE 115-a (e.g., an example of the UEs 115 as described with respect to FIG. 1), and a cell 235 (e.g., an example of the cells or coverage areas 110 as described with respect to FIG. 1). The wireless communications system 200 may also include one or more GNSS entities 230 (e.g., a GNSS satellite), which may be part of a GNSS. In some aspects, the UE 115-a may transmit RACH signaling 215 to the NTN entity 225 while in a connected mode (e.g., radio resource control (RRC) connected mode) associated with the NTN entity 225, where the RACH signaling 215 may be based on control signaling 220 and RACH configuration(s) 210 received from the NTN entity 225 and a state of the UE 115-a with respect to the GNSS.

In some cases, the UE 115-a may enter a connected mode (e.g., establish a connection 205) with the NTN entity 225 while in a GNSS state or a GNSS-less state. For example, if the UE 115-a is in the GNSS-less state (e.g., unable to or incapable of using a GNSS to determine location information), the NTN entity 225 (e.g., and the NTN) may provide communication service during emergencies or disaster, for military uses, or for some indoor or vehicular uses. In some aspects, the connection 205 between the UE 115-a and the NTN entity 225 may be supplementary to or a substitute for communicating with the GNSS entity 230. For example, being in the GNSS state (e.g., communicating with the GNSS entity 230) may allow for more efficient and high-performance communications between the UE 115-a and the NTN entity 225, but the NTN entity 225 may also provide resilient services to the UE 115-a when the UE 115-a is in a GNSS-less state. A UE 115 may be incapable of using the GNSS because it lacks one or more components (e.g., hardware or software components) or access permissions (e.g., subscriptions) required to facilitate use of the GNSS. A UE 115 may be unable to obtain its location using the GNSS because it is incapable of using the GNSS, or a UE 115 may be unable to obtain its location using the GNSS due to some more temporary condition, such as signal blockage as one such example, that prevents an otherwise GNSS-capable UE 115 from being able to obtain its location using the GNSS at some particular time.

The UE 115-a may communicate one or more signals (e.g., time-continuous signals) with the NTN entity 225 based on being in the connected mode. In some cases, a signal communicated from or to the UE 115-a (e.g., via an antenna port and subcarrier spacing configuration) via one or more OFDM symbols in a subframe for any physical channel or signal may be defined using a cyclic prefix. In some examples, the cyclic prefix may be an extended (e.g., long) cyclic prefix or a normal (e.g., short) cyclic prefix. In some examples, the cyclic prefix may reduce inter-symbol interference (ISI) and generally improve a quality of the signal.

In some cases, an uplink frame from the UE 115-a may correspond to a downlink frame at the UE 115-a. For example, an uplink frame for transmission from the UE 115-a may start before a corresponding downlink frame by a timing advance TTA (e.g., in units of time, including seconds, frames, symbols, or any combination thereof). In some cases, the timing advance may be based on one or more quantities. For example, the timing advance TTA may be determined by Equation 1:

$${T}_{TA} = ( {N}_{TA} + {N}_{TA , offset} + {N}_{TA , adj common} + {N}_{TA , adj UE} ) {T}_{c} . \qquad Eq . 1$$

In Equation 1, NTA may be a base timing advance (e.g., and may be set to zero for PRACH or RACH signaling), N_{TA,Ofset} may be a timing advance offset which may be indicated to or derived by the UE 115-a via one or more control signals (e.g., ServiceCellConfigCommon, ServiceCellConfigCommonSIB), N_{TA,adj common} may be a timing advance adjustment that is common for a cell (e.g., indicated to the UE 115-a by one or more control signals), N_{TA,adj UE} may be a UE-specific timing advance adjustment, and Tc may be a timing constant (e.g., 1/(480 kHz*4096)=0.509 nanosecond). As used herein, an “offset” or “timing advance” may refer to TTA, one or more variables from Equation 1, or any combination thereof.

In some examples, the UE 115-a may communicate the RACH signaling 215 (e.g., signaling) of a RACH procedure with the NTN entity 225 based on an occurrence of one or more RACH triggering events. In the case of a four step RACH procedure, the RACH signaling 215 may include one or more of four messages (e.g., signaling, MSG1, MSG2, MSG3, and MSG4), where the UE 115-a may transmit two of the messages (e.g., MSG1 and MSG3) and may receive two of the messages (e.g., MSG2 and MSG4). In the case of a two-step RACH procedure, the RACH signaling 215 may include 2 messages (e.g., MSGA and MSGB), where the UE 115-a may transmit one message (e.g., MSGA, which may include aspects of MSG1 and MSG3) and may receive one message (e.g., MSGB, which may include aspects of MSG2 and MSG4).

Some RACH triggering events may be applicable to multiple modes of the UE 115-a, including the connected mode, an inactive mode, and an idle mode. For example, such RACH triggering events may include performing an initial access from an RRC idle state, transitioning from RRC inactive to RRC connected mode, performing an RRC connection re-establishment, performing a handover procedure, downlink or uplink data (e.g., such as a PDCCH-order) arriving at the UE 115-a while the UE 115-a is out of sync with the transmitter of the downlink or uplink data, receiving an on-demand system information message (e.g., a system information block 1 (SIB1)), performing beam failure recovery, experiencing a scheduling request failure, performing a synchronous reconfiguration, establishing a time alignment during the addition of a secondary cell (SCell), or any combination thereof.

Additionally, or alternatively, some RACH triggering events may be associated with the connected mode (e.g., RRC connected mode, while in a connected mode with the NTN entity 225, while the connection 205 is established, connected mode RACH triggering events). Such RACH triggering events may include some of the RACH triggering events applicable to multiple modes (e.g., listed above), one or more other RACH triggering events, or both. For example, RACH triggering events associated with (e.g., valid while in) the connected mode may include downlink or uplink data arrival (e.g., such as a PDCCH-order) when an uplink synchronization status is “non-synchronized,” uplink data arrival when there are no physical uplink control channel (PUCCH) resources for scheduling requests available, performing a handover procedure, experiencing a scheduling request failure, receiving an explicit request to perform a RACH procedure via RRC signaling based on synchronous reconfiguration, performing an RRC connection resume procedure (e.g., from an RRC inactive state), establishing time alignment for a primary or a secondary timing advance group (TAG), requesting another system information message (e.g., SIB1), performing a beam failure recovery procedure, encountering consistent uplink listen-before-talk failure on a special cell (SpCell), some positioning procedures that utilize RACH procedures (e.g., when acquiring timing advance for UE positioning), performing early uplink synchronization with a lower layer triggered mobility (LTM) candidate cell, performing a RACH-based LTM cell switch, or any combination thereof. As used herein, the “RACH triggering event” may include one or more of the RACH triggering events listed herein, or one or more not listed herein.

For some RACH triggering events associated with the connected mode, the UE 115-a may be semi-statically configured (e.g., via medium access control (MAC) signaling, via RRC signaling) with a RACH configuration 210 that is UE-dedicated (e.g., for contention free random access (CFRA), used solely for the UE 115-a). For example, the RACH configuration(s) 210 for such RACH triggering events may include or be indicated by one or more information elements, including BeamFailureRecoveryConfig (e.g., for performing a beam failure recovery procedure), RACH-ConfigDedicated (e.g., for performing a handover, for reconfiguring with synchronization), SI-RequestConfig (e.g., for requesting another system information message), or any combination thereof. In some cases, if the RACH configuration 210 for the UE is not UE-dedicated for such RACH triggering events, the UE 115-a may utilize a common RACH configuration for such RACH triggering events.

In some cases, the UE 115-a may transmit the RACH signaling 215 (e.g., as part of a RACH procedure) while in the GNSS-less state. If the RACH configuration(s) 210 received at the UE 115-a do not include a GNSS-less RACH configuration, the UE 115-a may apply one or more UE adjusted offsets (e.g., timing advance, core doppler compensation (e.g., frequency adjustment)) to the RACH signaling 215, which may be derived from one or more sources. In one example, the UE 115-a may derive the UE adjusted offsets from the control signaling 220. For example, the NTN entity 225 may indicate, in the control signaling 220, one or more common offsets (e.g., a common timing advance, a common frequency adjustment, common for the cell 235) for UEs 115 in the GNSS-less state, along with one or more derivatives (e.g., different orders of derivatives) of the one or more common offsets (e.g., a first derivative of the timing advance (e.g., the frequency adjustment), a second derivative of the timing advance (e.g., a timing advance drift rate)). In some examples, the control signaling 220 may also indicate a validity indicator associated with the common offsets, the one or more derivatives, or any both. For example, the validity indicator may indicate a duration for which the common offsets, the one or more derivatives, or any combination thereof, are valid (e.g., if the UE 115-a obtains the offsets at time t, the validity indicator may indicate a duration T, where the offsets are valid until time t+T).

In a second example, the UE 115-a may derive the UE adjusted offsets from a reference location 250. For example, the NTN entity 225 may indicate (e.g., in the control signaling 220) a reference location 250 (e.g., reference coordinates) within the cell 235. The UE 115-a may compute a common timing advance, a common frequency adjustment, or both, based on the reference location 250 (e.g., as if the UE 115-a were at the reference location 250). In some cases, the network entity 105 may also indicate a change of the reference location 250 over time (e.g., a location drift, a location drift rate), along with a validity indicator associated with the reference location 250.

In a third example, the UE 115-a may derive the UE adjusted offsets from recently received tracking area code commands (TACs), frequency area codes commands (FACs), or both. For example, the UE 115-a may determine the timing advance, the frequency advance, or both, based on one or more TACs, one or more FACs, or both, that were accumulated (e.g., received, recorded, stored, buffered in memory) at the UE 115-a within a duration (e.g., in a previous T units of time).

The RACH configuration(s) 210 may be based on the state of the UE 115-a with respect to the GNSS (e.g., or the GNSS entity 230). In one example, the RACH configuration(s) 210 may include two or more UE-dedicated RACH configurations for each of one or more RACH triggering event associated with the connected mode. Each UE-dedicated RACH configuration may indicate RACH resources (e.g., ROs, cyclic prefixes) for performing a RACH procedure in response to an occurrence of the corresponding RACH triggering event. For example, the RACH configurations 210 may include a GNSS RACH configuration and a GNSS-less RACH configuration for each RACH triggering event. The GNSS RACH configuration may indicate different RACH resources (e.g., cyclic prefixes) from GNSS-less RACH configuration, and the GSS-less RACH configuration may indicate some information (e.g., offsets, a timing advance, a frequency adjustment) that the GNSS RACH configuration may not indicate. In some examples, the UE 115-a may select (e.g., pick up), based on the state of the UE with reference to the GNSS at or sometime after an occurrence of a RACH triggering event, one of the RACH configuration(s) 210 to use in a RACH procedure in response to the occurrence of the RACH triggering event. Additionally, or alternatively, for each UE-dedicated RACH configuration, the NTN entity 225 may configure the UE 115-a with more than one “RACH-configuration generic.”

In another example, the UE 115-a may be in a GNSS-less state. Based on the GNSS-less state of the UE 115-a, the RACH configuration(s) 210 may indicate a single UE-dedicated RACH configuration for the UE 115-a corresponding to each RACH triggering event (e.g., associated with the connected mode). In one case, the single UE-dedicated RACH configuration may be a legacy RACH configuration, which may be unassociated with the GNSS (e.g., may not include any information based on the GNSS or the state of the UE 115-a). In another case, the single UE-dedicated RACH configuration may be a GNSS RACH configuration (e.g., valid for UEs 115 in the GNSS state). If the UE 115-a is in the GNSS-less state, the UE 115-a may use the resources (e.g., RO, cyclic prefix) indicated by the GNSS RACH configuration, but may apply a timing advance and a frequency adjustment (e.g., uplink timing advance and frequency adjustment) received in the control signaling 220 the RACH signaling 215. In some cases, the network signaled timing advance and frequency adjustment may be common to UEs 115 in the cell 235 or dedicated to the UE 115-a.

In some cases, the UE 115-a may transmit a capability report 245 to the NTN entity 225, and the RACH configuration(s) 210 may be based on the capability report 245. For example, the capability report 245 may indicate whether the UE 115-a supports or is in the GNSS state, the GNSS-less state, both, or one of the states explicitly. For example, the RACH configuration(s) 210 may include the GNSS RACH configuration, the GNSS-less RACH configuration, or both, based on the capability report 245. For example, the NTN entity 225 may configure the RACH configuration 210 to include one or more RACH configurations for each RACH triggering event that are associated with each state supported by the UE 115-a or in which the UE 115-a is.

In some cases, RACH configuration(s) 210 may not explicitly indicating a UE-dedicated RACH configuration for one or more RACH triggering events (e.g., associated with the connected mode). In such cases, the RACH configurations 210 may indicate one or more common RACH configurations for the cell 235, and the UE 115-a may derive RACH resources (e.g., and a RACH configuration) from the common RACH configuration based on the state of the UE 115-a with respect to the GNSS. For example, the UE 115-a may receive control signaling 220 that includes a first information element (e.g., RACH-ConfigCommon) that indicates a common RACH configuration (e.g., RACH-ConfigGeneric, Synchronization Signal Block (SSB) per RO, a common config across the cell 235). Additionally, or alternatively, the control signaling may include a second information element (e.g., SI-RequestConfig) that indicates an optional common RACH configuration for a RACH triggering event (e.g., requesting another system information message, RACH-ConfigSI). If the UE 115-a does not receive the second information element, the UE 115-a may derive ROs for the RACH signaling 215 from the first information element (e.g., RACH-ConfigCommon) for the RACH triggering event (e.g., SI request).

In some cases, the RACH configuration 210 received at the UE 115-a may include one or more common RACH configurations (e.g., RACH-ConfigCommon) for any RACH triggering event in the cell 235, where the one or more common RACH configurations may include a GNSS RACH configuration (e.g., a legacy RACH configuration), a GNSS-less RACH configuration, or both. That is, the RACH configurations 210 may not correspond to a specific RACH triggering event for the UE 115-a in the connected mode (e.g., no specific RACH configuration may be provided for the RACH triggering events). In one example, the UE 115-a may derive RACH resources from the one or more common RACH configuration. For example, the UE may select appropriate RACH resource from the common RACH configuration based on the state of the UE 115-a with respect to the GNSS. In some cases, if one or more cell common RACH configurations include a single GNSS (e.g., or legacy) RACH configuration, a UE 115 in the GNSS-less state may apply a common timing advance and frequency adjustment to the RACH signaling 215, as indicated in the common RACH configuration. Additionally, or alternatively, a UE 115 in the GNSS state may derive a timing advance, a frequency adjustment, or both, from measurements made on GNSS signaling 240, and may apply the timing advance, the frequency adjustment, or both, that is derived from the GNSS measurements to the RACH signaling 215.

In some cases, a UE 115 in a GNSS-less state may not consider a GNSS RACH configurations (e.g., or a legacy RACH configuration) as valid for communicating the RACH signaling 215 based on one or more conditions. For example, if the RACH configuration 210 includes a single GNSS RACH configuration (e.g., or legacy RACH configuration) for a RACH triggering event and the UE 115-a is in the GNSS-less state, the UE 115-a may consider the RACH configuration 210 invalid for the GNSS-less state, unless one or more conditions associated with the RACH configuration 210 are satisfied. For example, the one or more conditions may include a length of a RACH format included in the RACH configuration 210 (e.g., the UE 115-a may consider the RACH configuration 210 invalid if the RACH format is short).

In some cases, the NTN entity 225 may transmit a PDCCH-order (e.g., a command or control signaling sent over PDCCH) to the UE 115-a based on a duration of inactivity or lack of synchronization of the UE 115-a with the NTN entity 225. The PDCCH-order may include a request that the UE 115-a perform a RACH procedure, and may indicate one or more RACH resources for the UE 115-a to use for the RACH procedure. In some cases, the UE 115-a may be in a first state with respect to the GNSS (e.g., the GNSS state), and the PDCCH-order may indicate a second state with respect to the GNSS, where the second state may be the same as or different from the first state. The PDCCH-order may request the UE 115-a to (e.g., indicate that the UE 115-a is to) transmit the RACH signaling 215 using a RACH configuration associated with the second state. If, for example, the UE 115-a is in the GNSS state and the PDCCH-order indicates the GNSS-less state as the second state, the UE 115-a may not use the GNSS (e.g., or any measurements associated with the GNSS) to derive a timing advance, a frequency adjustment, or both, for transmitting the RACH signaling 215 of the RACH procedure.

Accordingly, the UE 115-a may receive RACH configurations 210 and transmit RACH signaling 215 while in the connected mode with the NTN entity 225 based on a state of the UE 115-a with respect to the GNSS. Accordingly, the wireless communications system 200 may more efficiently accommodate UEs 115 of different capabilities and states, allowing for improved wireless communications.

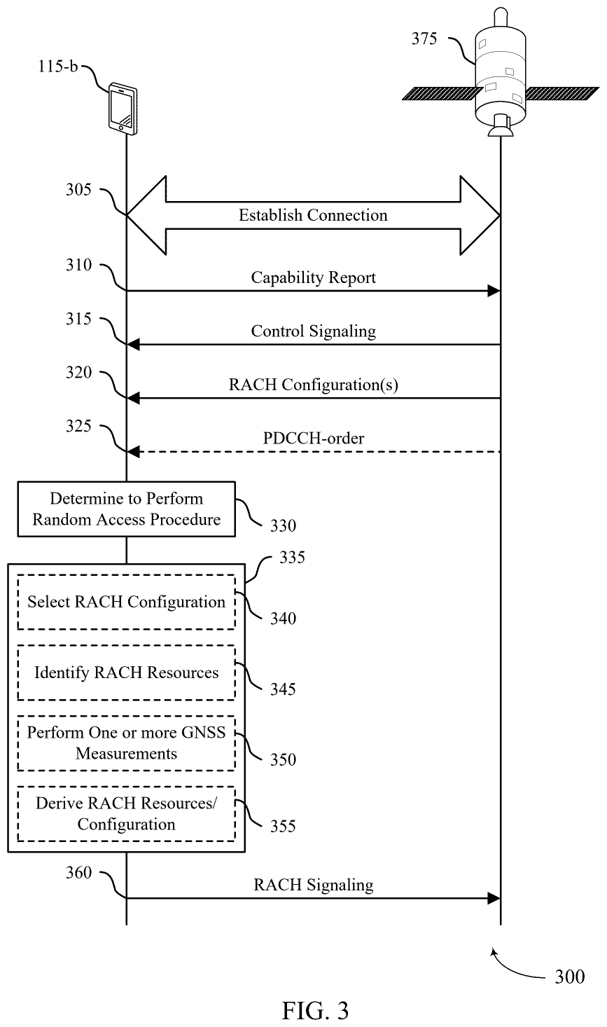

FIG. 3 shows an example of a process flow 300 that supports state-based connected mode random access for wireless communications in accordance with one or more aspects of the present disclosure. In some cases, aspects of the process flow 300 may implement or be implemented by aspects of FIGS. 1 and 2. For example, the process flow 300 may include a UE 115-b (e.g., an example of the UEs 115 described with respect to FIGS. 1 and 2) and an NTN entity 375 (e.g., an example of the NTN entities 225 described with respect to FIG. 2). In some aspects, the UE 115-b may, while in a connected mode with the NTN entity 375, transmit RACH signaling to the NTN entity 375 according to a RACH configuration (e.g., or RACH resources) based on a state of the UE 115-b with respect to a GNSS.

In the following description of process flow 300, the operations may be performed in a different order than the order shown, or other operations may be added or removed from the process flow 300. For example, some operations may also be left out of process flow 300, may be performed in different orders or at different times, or other operations may be added to process flow 300. Although the UE 115-b and the NTN entity 375 are shown performing the operations of process flow 300, some aspects of some operations may also be performed by one or more other wireless devices or network devices, such as those described herein with respect to FIGS. 1 and 2.

At 305, the UE 115-b may enter a connected mode associated with the NTN entity 375 based on being within a cell (e.g., such as the cell 235) served by the NTN entity. That is, the UE 115-b may establish a connection with the NTN entity 375 via, for example, an initial RACH procedure based on entering the cell served by the NTN entity 375. In some cases, the UE 115-b may be in a state with respect to a GNSS. For example, the state of the UE 115-b may indicate whether the UE 115-b is able to obtain its location using the GNSS, whether the UE 115-b is capable of using the GNSS, or both. A GNSS state may be a state in which the UE 115-b is able to obtain its location using the GNSS, is capable of using the GNSS, or both, and a GNSS-less state may be a state in which the UE 115-b is unable to obtain its location using the GNSS, is incapable of using the GNSS, or both.

At 310, the UE 115-b may transmit a capability report to the NTN entity 375, where the capability report may indicate whether (e.g., that) the UE supports GNSS RACH configurations (e.g., RACH configuration for UEs 115 in the GNSS state)), whether (e.g., that) the UE supports GNSS-less RACH configurations (e.g., RACH configuration for UEs in the GNSS-less state), or both. Additionally, or alternatively, the capability report may indicate a current state of the UE 115-b with respect to the GNSS.

At 315, the UE 115-b may receive control signaling indicating an uplink timing advance, a frequency adjustment, or both, associated with the RACH procedure. In some cases, the uplink timing advance, the frequency adjustment, or both, may be common for one or more UEs 115 in a cell served by the NTN entity 375, or may be dedicated to the UE 115-b. Additionally, the UE 115-b may receive the first control signaling from the NTN entity 375 or one or more other network entities 105. In some examples, the control signaling may be broadcasted from the NTN entity 375 to multiple UEs 115 within the cell served by the NTN entity 375.

At 320, the UE 115-b may receive control signaling indicating one or more UE-dedicated or common RACH configurations. In some cases, the control signaling may indicate the one or more RACH configurations based at least in part on the capability report. In some examples, the control signaling may indicate multiple RACH configurations (e.g., UE-dedicated RACH configurations) that correspond to a RACH triggering event (e.g., associated with the connected mode), wherein the multiple RACH configurations may include a GNSS RACH configuration (e.g., a RACH configuration for UEs in the GNSS state) and a GNSS-less RACH configuration (e.g., a RACH configuration for UEs in the GNSS-less state).

Additionally, or alternatively, the control signaling may indicate one or more common RACH configurations that are common for one or more UEs 115 (e.g., including the UE 115-b) within the cell served by the NTN entity 375. For example, the one or more common RACH configurations may indicate a common timing advance, a common frequency adjustment, or both, associated with a RACH procedure for the UE 115-b.

In some cases, the control signaling may indicate a single RACH configuration (e.g., UE-dedicated RACH configuration) for one or more RACH triggering events. For example, if the UE 115-b is in or supports the GNSS-less state (e.g., the state of the UE with respect to the GNSS that includes the UE being unable to obtain its location using the GNSS, being incapable of using the GNSS, or both), the single RACH configuration may be a GNSS-less RACH configuration. Additionally, or alternatively, the single RACH configuration may be a GNSS RACH configuration (e.g., when the UE 115-b is in the GNSS-less state or the GNSS state). Additionally, or alternatively, the control signaling may fail to indicate a RACH configuration for one or more RACH triggering events.

At 325, based at least in part on the state of the UE 115-b with respect to the GNSS, the UE 115-b may receive a PDCCH-order (e.g., control signaling) requesting that the UE 115-b perform a RACH procedure (e.g., the PDCCH-order may be the RACH triggering event). For example, the UE 115-b may be in the GNSS state, and may receive the PDCCH-order from the NTN entity 375 mased on being in the GNSS state and an inactivity of the UE 115-b. In some cases, the PDCCH-order may further indicate a second state of the UE 115-b with respect to the GNSS, where the second state the same as (e.g., GNSS state) or different than (e.g., GNSS-less state) the state of the UE 115-b with respect to the GNSS. For example, the PDCCH-order may request that the UE perform a RACH procedure according to a GNSS-less RACH configuration. In some examples, receiving the PDCCH-order may be the RACH triggering event.

At 330, the UE 115-b may identify the occurrence of the RACH triggering event (e.g., receiving the PDCCH-order, one or more other RACH triggering evets associated with the connected mode), and may determine to perform a RACH procedure with the NTN entity (e.g., while in the connected mode) based on the occurrence of the RACH triggering event. For example, the RACH triggering event may be a RACH triggering event that is associated with the connected mode.

At 335, the UE 115-b may determine one or more RACH resources, a RACH configuration, or both, for performing the RACH procedure. The UE 115-b may perform one or more actions (e.g., 340 through 355) to determine the one or more RACH resources or the RACH configuration based on the control signaling received at 315, the one or more RACH configurations received at 320, and the state of the UE 115-b with respect to the GNSS.

In some cases, the UE 115-a may (e.g., at 340) select the RACH configuration from among multiple RACH configurations received at 320 (e.g., for the RACH triggering event) based on the state of the UE with respect to the GNSS. For example, if the UE 115-b received a GNSS RACH configuration and a GNSS-less RACH configuration for the RACH triggering event at 320, the UE 115-b may select a RACH configuration for the RACH triggering event associated with the state in which the UE 115-b is. Additionally, or alternatively, the UE 115-a may (e.g., at 345) identify one or more RACH resources from the one or more common RACH configurations received at 320 based on the state of the UE with respect to the GNSS. For example, if the UE 115-b is in the GNSS-less state, the UE 115-b may identify one or more of the common timing advance and the common frequency advance to use in the RACH procedure, and may use the resources (e.g., RO, cyclic shift) indicated in a UE-specific RACH configuration for the triggering event indicated at 320 (e.g., whether from a GNSS or GNSS-less RACH configuration).

In some cases, the UE 115-b may be in the GNSS state (e.g., the UE 115-b may be able to obtain its location using the GNSS, being capable of using the GNSS, or both) and may (e.g., at 350) perform one or more measurements associated with the GNSS to derive a UE-specific timing advance associated with the RACH procedure, a UE-specific frequency adjustment associated with the RACH procedure, or both. For example, the UE 115-b may passively measure one or more signals transmitted by a GNSS entity (e.g., such as the GNSS signaling 240 from the GNSS entity 230 described with respect to FIG. 2), and may determine the UE-specific timing advance, the UE-specific frequency adjustment, or both, based on the measurements. For example, if the UE 115-b does not receive a UE-dedicated RACH configuration (e.g., or an GNSS RACH configuration) at 320, the UE 115-b may determine the timing advance, the frequency adjustment, or both, based on the measurements.

Additionally, or alternatively, the UE 115-b may determine the RACH configuration for the RACH procedure based on the second state indicated by the PDCCH-order at 325. For example, if the PDCCH-order received at 325 indicates the UE 115-b to use a GNSS-less RACH configuration and the UE 115-b is in the GNSS state, the UE 115-b may (e.g., at 355) derive a timing advance for the RACH configuration, a frequency adjustment for the RACH configuration, or both, from another RACH configuration that is unassociated with the GNSS. For example, the other RACH configuration may be a legacy RACH configuration received at 320, a GNSS-less RACH configuration received at 320, a common RACH configuration received at 320, or any combination thereof. Additionally, or alternatively, if the PDCCH order indicates for the UE 115-b to use a RACH configuration associated with the same state in which the UE 115-b is in, the UE 115-b may determine to use that RACH configuration for the RACH procedure.

In some cases, the UE 115-b may be in the GNSS-less state (e.g., the UE 115-b may be unable to obtain its location using the GNSS, being incapable of using the GNSS, or both). If the UE 115-b in the GNSS-less state receives a single GNSS RACH configuration at 320 and the single GNSS RACH configuration does not satisfy one or more conditions, the UE 115-b may (e.g., at 355) derive a RACH configuration for performing the RACH procedure from another RACH configuration (e.g., a common RACH configuration) that is different from the single GNSS RACH configuration. For example, the one or more conditions may include that the format of the GNSS RACH configuration be a long format (e.g., cannot be short) if the UE 115-b is in the GNSS-less mode. Additionally, or alternatively, if the UE 115-b receives a single RACH configuration associated with the same state in which the UE 115-b is in, the UE 115-b may determine to use the single RACH configuration for the RACH procedure.

At 360, the UE 115-b may transmit, as part of the RACH procedure triggered by the RACH triggering event, a RACH signal according to the RACH resources (e.g., an RO, a cyclic shift) and RACH configuration determined at 335 based on the state of the UE 115-b with respect to the GNSS.

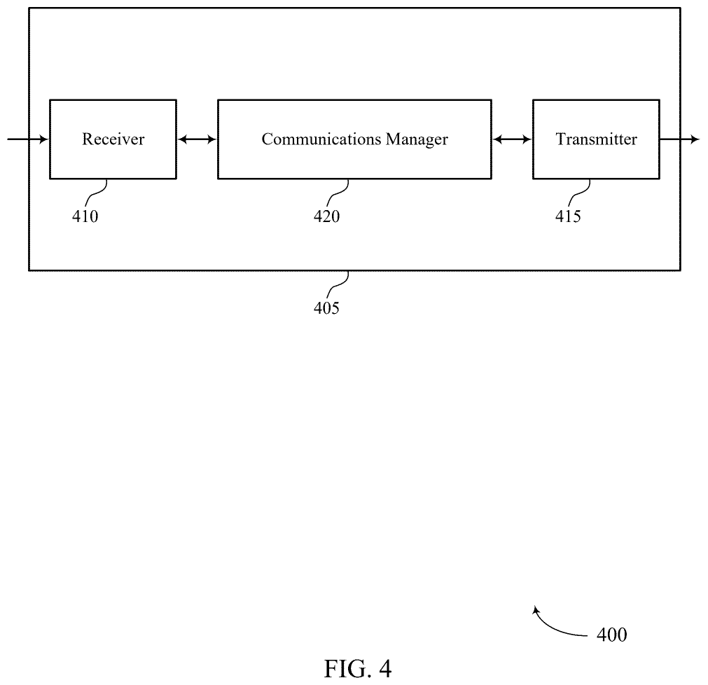

FIG. 4 shows a block diagram 400 of a device 405 that supports state-based connected mode RACH for wireless communications in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to state-based connected mode RACH for wireless communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to state-based connected mode RACH for wireless communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of state-based connected mode RACH for wireless communications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for entering a connected mode associated with an NTN entity based on being within a cell served by the NTN entity. The communications manager 420 is capable of, configured to, or operable to support a means for determining to perform a RACH procedure with the NTN entity while in the connected mode based on an occurrence of a RACH triggering event associated with the connected mode. The communications manager 420 is capable of, configured to, or operable to support a means for transmitting, as part of the RACH procedure, a RACH signal based on a RACH configuration and a state of the UE with respect to a GNSS.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources. For example, a UE 115 applying the techniques described herein may perform a RACH procedure using a RACH configuration tailored to a state of the UE 115 with respect to the GNSS, improving communication quality and utilizing communication resources more efficiently.

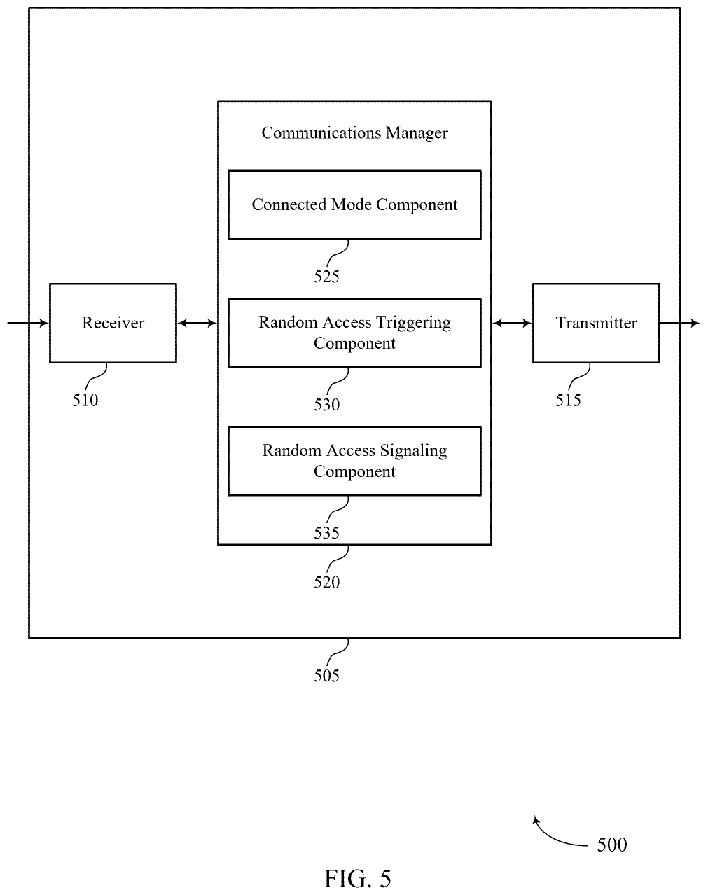

FIG. 5 shows a block diagram 500 of a device 505 that supports state-based connected mode RACH for wireless communications in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to state-based connected mode RACH for wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to state-based connected mode RACH for wireless communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of state-based connected mode RACH for wireless communications as described herein. For example, the communications manager 520 may include a connected mode component 525, a RACH triggering component 530, a RACH signaling component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The connected mode component 525 is capable of, configured to, or operable to support a means for entering a connected mode associated with an NTN entity based on being within a cell served by the NTN entity. The RACH triggering component 530 is capable of, configured to, or operable to support a means for determining to perform a RACH procedure with the NTN entity while in the connected mode based on an occurrence of a RACH triggering event associated with the connected mode. The RACH signaling component 535 is capable of, configured to, or operable to support a means for transmitting, as part of the RACH procedure, a RACH signal based on a RACH configuration and a state of the UE with respect to a GNSS.

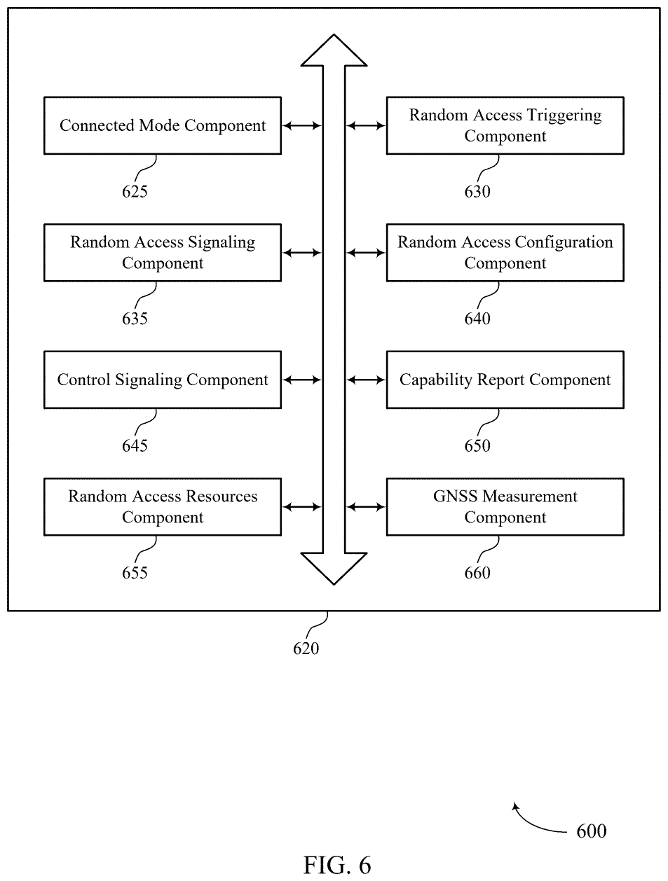

FIG. 6 shows a block diagram 600 of a communications manager 620 that supports state-based connected mode RACH for wireless communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of state-based connected mode RACH for wireless communications as described herein. For example, the communications manager 620 may include a connected mode component 625, a RACH triggering component 630, a RACH signaling component 635, a RACH configuration component 640, a control signaling component 645, a capability report component 650, a RACH resources component 655, an GNSS Measurement component 660, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The connected mode component 625 is capable of, configured to, or operable to support a means for entering a connected mode associated with an NTN entity based on being within a cell served by the NTN entity. The RACH triggering component 630 is capable of, configured to, or operable to support a means for determining to perform a RACH procedure with the NTN entity while in the connected mode based on an occurrence of a RACH triggering event associated with the connected mode. The RACH signaling component 635 is capable of, configured to, or operable to support a means for transmitting, as part of the RACH procedure, a RACH signal based on a RACH configuration and a state of the UE with respect to a GNSS.

In some examples, the state of the UE includes whether the UE is able to obtain its location using the GNSS, whether the UE is capable of using the GNSS, or both.

In some examples, the RACH configuration component 640 is capable of, configured to, or operable to support a means for receiving control signaling indicating a set of multiple RACH configurations that corresponds to the RACH triggering event, where the set of multiple RACH configurations includes a first RACH configuration for UEs in a first state with respect to the GNSS and a second RACH configuration for UEs in a second state with respect to the GNSS.

In some examples, the RACH configuration component 640 is capable of, configured to, or operable to support a means for selecting the RACH configuration from among the set of multiple RACH configurations based on the state of the UE with respect to the GNSS.

In some examples, the state of the UE with respect to the GNSS includes the UE being unable to obtain its location using the GNSS, being incapable of using the navigation satellite system, or both, and the RACH configuration component 640 is capable of, configured to, or operable to support a means for receiving control signaling indicating a single RACH configuration that is for UEs in a first state with respect to the GNSS, the first state including the UE being unable to obtain its location using the GNSS or being incapable of using the GNSS, where the RACH configuration includes the single RACH configuration.

In some examples, the state of the UE with respect to the GNSS includes the UE being unable to obtain its location using the GNSS, being incapable of using the navigation satellite system, or both, and the control signaling component 645 is capable of, configured to, or operable to support a means for receiving first control signaling indicating an uplink timing advance, a frequency adjustment, or both, associated with the RACH procedure. In some examples, the RACH configuration component 640 is capable of, configured to, or operable to support a means for receiving second control signaling indicating the RACH configuration, where the RACH configuration includes RACH resources for UEs that are able to obtain their location using the GNSS or capable of using the GNSS, and the RACH signal is transmitted based on the RACH resources and one or both of the uplink timing advance and the frequency adjustment.

In some examples, at least one of the uplink timing advance or the frequency adjustment is common for one or more UEs within the cell.

In some examples, at least one of the uplink timing advance or the frequency adjustment is dedicated to the UE.

In some examples, the capability report component 650 is capable of, configured to, or operable to support a means for transmitting a capability report indicating that the UE supports RACH configuration for UEs in a first state with respect to the GNSS, that the UE supports RACH configuration for UEs in a second state with respect to the GNSS, or both. In some examples, the RACH configuration component 640 is capable of, configured to, or operable to support a means for receiving control signaling indicating one or more RACH configurations based on the capability report, the one or more RACH configurations including the RACH configuration.

In some examples, the RACH configuration component 640 is capable of, configured to, or operable to support a means for receiving one or more common RACH configurations that are common for one or more UEs within the cell, the RACH configuration included in the one or more common RACH configurations. In some examples, the RACH resources component 655 is capable of, configured to, or operable to support a means for identifying RACH resources associated with the RACH configuration based on the state of the UE with respect to the GNSS. In some examples, the one or more common RACH configurations indicate a common timing advance, a common frequency adjustment, or both, associated with the RACH procedure. In some examples, the state of the UE with respect to the GNSS includes the UE being unable to obtain its location using the GNSS, being incapable of using the GNSS, or both. In some examples, the RACH signal is transmitted based on the common timing advance, the common frequency adjustment, or both.

In some examples, the state of the UE with respect to the GNSS includes the UE being able to obtain its location using the GNSS, being capable of using the navigation satellite system, or both, and the GNSS Measurement component 660 is capable of, configured to, or operable to support a means for performing one or more measurements associated with the GNSS to derive a UE-specific timing advance associated with the RACH procedure, a UE-specific frequency adjustment associated with the RACH procedure, or both based on the state of the UE with respect to the GNSS, where the RACH signal is transmitted based on one or both of the UE-specific timing advance and the UE-specific frequency adjustment.

In some examples, the state of the UE with respect to the GNSS includes the UE being unable to obtain its location using the GNSS, being incapable of using the navigation satellite system, or both, and the RACH configuration component 640 is capable of, configured to, or operable to support a means for receiving control signaling indicating a single second RACH configuration corresponding to the RACH triggering event. In some examples, the state of the UE with respect to the GNSS includes the UE being unable to obtain its location using the GNSS, and the RACH configuration component 640 is capable of, configured to, or operable to support a means for deriving the RACH configuration from another RACH configuration that is different from the single second RACH configuration based on the state of the UE and one or more conditions associated with the single second RACH configuration.

In some examples, the state of the UE with respect to the navigation satellite system comprises the UE being able to obtain its location using the navigation satellite system, being capable of using the navigation satellite system, or both, and the occurrence of the RACH triggering event (e.g., as supported by the RACH triggering component 630) includes the UE receiving, based on the state of the UE with respect to the GNSS, control signaling requesting that the UE perform the RACH procedure, the control signaling further indicating a second state with respect to the GNSS, the second state the same as or different than the state of the UE with respect to the GNSS, where the RACH configuration used for transmitting the RACH signal is based on the second state indicated by the control signaling.

In some examples, the control signaling requests that the UE performs the RACH procedure according to the RACH configuration for UEs that are unable to obtain their location using the GNSS or are incapable of using the GNSS, and the RACH configuration component 640 is capable of, configured to, or operable to support a means for deriving a timing advance of the RACH configuration used for transmitting the RACH signal, a frequency adjustment of the RACH configuration used for transmitting the RACH signal, or both from another RACH configuration that is unassociated with the GNSS.

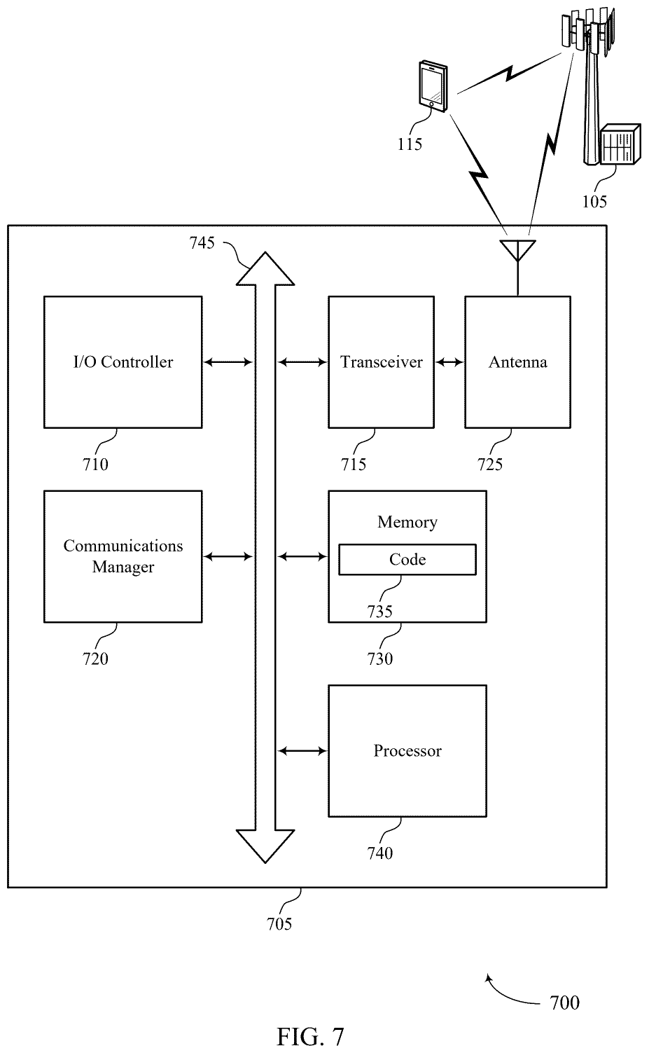

FIG. 7 shows a diagram of a system 700 including a device 705 that supports state-based connected mode RACH for wireless communications in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include RACH memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting state-based connected mode RACH for wireless communications). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for entering a connected mode associated with an NTN entity based on being within a cell served by the NTN entity. The communications manager 720 is capable of, configured to, or operable to support a means for determining to perform a RACH procedure with the NTN entity while in the connected mode based on an occurrence of a RACH triggering event associated with the connected mode. The communications manager 720 is capable of, configured to, or operable to support a means for transmitting, as part of the RACH procedure, a RACH signal based on a RACH configuration and a state of the UE with respect to a GNSS.

By including or configuring the communications manager 720 in accordance with examples as described herein, the device 705 may support techniques for reduced latency and more efficient utilization of communication resources. For example, a UE 115 utilizing the techniques described herein may perform a RACH procedure using a RACH configuration tailored to the state of the UE with respect to the GNSS, which may reduce failed RACH attempts (e.g., and thus latency) and allow for improved utilization of wireless communication resources.

In some examples, the communications manager 720 may be configured to perform various operations (e.g., receiving, monitoring, transmitting) using or otherwise in cooperation with the transceiver 715, the one or more antennas 725, or any combination thereof. For example, the communications manager 520 may be configured to receive or transmit messages or other signaling as described herein via the transceiver 715. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of state-based connected mode RACH for wireless communications as described herein, or the at least one processor 740 and the at least one memory 730 may be otherwise configured to, individually or collectively, perform or support such operations.

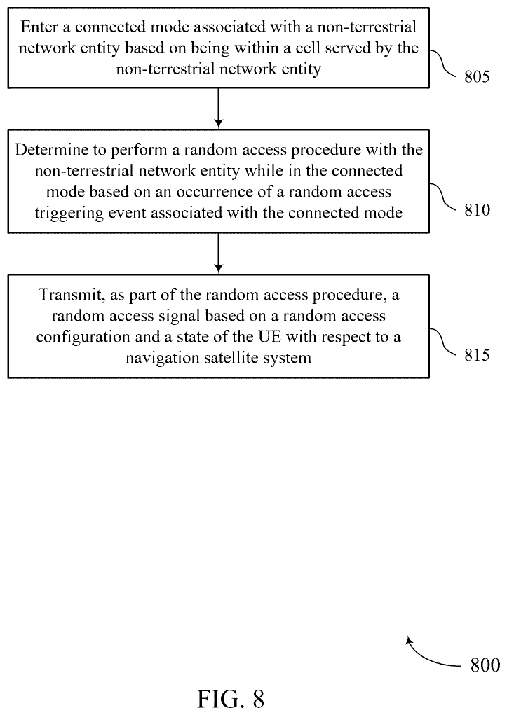

FIG. 8 shows a flowchart illustrating a method 800 that supports state-based connected mode RACH for wireless communications in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include entering a connected mode associated with an NTN entity based on being within a cell served by the NTN entity. The operations of 805 may be performed in accordance with examples as disclosed herein. In some examples, aspects of the operations of 805 may be performed by a connected mode component 625 as described with reference to FIG. 6. Additionally, or alternatively, means for performing 805 may, but not necessarily, include, for example, antenna 725, transceiver 715, communications manager 720, memory 730 (including code 735), processor 740 and/or bus 745.

At 810, the method may include determining to perform a RACH procedure with the NTN entity while in the connected mode based on an occurrence of a RACH triggering event associated with the connected mode. The operations of 810 may be performed in accordance with examples as disclosed herein. In some examples, aspects of the operations of 810 may be performed by a RACH triggering component 630 as described with reference to FIG. 6. Additionally, or alternatively, means for performing 810 may, but not necessarily, include, for example, antenna 725, transceiver 715, communications manager 720, memory 730 (including code 735), processor 740 and/or bus 745.

At 815, the method may include transmitting, as part of the RACH procedure, a RACH signal based on a RACH configuration and a state of the UE with respect to a GNSS. The operations of 815 may be performed in accordance with examples as disclosed herein. In some examples, aspects of the operations of 815 may be performed by a RACH signaling component 635 as described with reference to FIG. 6. Additionally, or alternatively, means for performing 815 may, but not necessarily, include, for example, antenna 725, transceiver 715, communications manager 720, memory 730 (including code 735), processor 740 and/or bus 745.

The following provides an overview of aspects of the present disclosure:
Aspect 1: A method for wireless communication at a UE, comprising: entering a connected mode associated with a NTN entity based at least in part on being within a cell served by the NTN entity; determining to perform a RACH procedure with the NTN entity while in the connected mode based at least in part on an occurrence of a RACH triggering event associated with the connected mode; and transmitting, as part of the RACH procedure, a RACH signal based at least in part on a RACH configuration and a state of the UE with respect to a navigation satellite system.
Aspect 2: The method of aspect 1, wherein the state of the UE comprises whether the UE is able to obtain its location using the navigation satellite system, whether the UE is capable of using the navigation satellite system, or both.
Aspect 3: The method of any of aspects 1 through 2, further comprising: receiving control signaling indicating a plurality of RACH configurations that corresponds to the RACH triggering event, wherein the plurality of RACH configurations comprises a first RACH configuration for UEs in a first state with respect to the navigation satellite system and a second RACH configuration for UEs in a second state with respect to the navigation satellite system.
Aspect 4: The method of aspect 3, further comprising: selecting the RACH configuration from among the plurality of RACH configurations based at least in part on the state of the UE with respect to the navigation satellite system.
Aspect 5: The method of any of aspects 1 through 4, wherein the state of the UE with respect to the navigation satellite system comprises the UE being unable to obtain its location using the navigation satellite system, being incapable of using the navigation satellite system, or both, the method further comprising: receiving control signaling indicating a single RACH configuration that is for UEs in a first state with respect to the navigation satellite system, the first state comprising the UE being unable to obtain its location using the navigation satellite system or being incapable of using the navigation satellite system, wherein the RACH configuration comprises the single RACH configuration.
Aspect 6: The method of any of aspects 1 through 5, wherein the state of the UE with respect to the navigation satellite system comprises the UE being unable to obtain its location using the navigation satellite system, being incapable of using the navigation satellite system, or both, the method further comprising: receiving first control signaling indicating an uplink timing advance, a frequency adjustment, or both, associated with the RACH procedure; and receiving second control signaling indicating the RACH configuration, wherein the RACH configuration comprises RACH resources for UEs that are able to obtain their location using the navigation satellite system or capable of using the navigation satellite system, and wherein the RACH signal is transmitted based at least in part on the RACH resources and one or both of the uplink timing advance and the frequency adjustment.
Aspect 7: The method of aspect 6, wherein at least one of the uplink timing advance or the frequency adjustment is common for one or more UEs within the cell.
Aspect 8: The method of aspect 6, wherein at least one of the uplink timing advance or the frequency adjustment is dedicated to the UE.
Aspect 9: The method of any of aspects 1 through 8, further comprising: transmitting a capability report indicating that the UE supports RACH configuration for UEs in a first state with respect to the navigation satellite system, that the UE supports RACH configuration for UEs in a second state with respect to the navigation satellite system, or both; and receiving control signaling indicating one or more RACH configurations based at least in part on the capability report, the one or more RACH configurations comprising the RACH configuration.
Aspect 10: The method of any of aspects 1 through 9, further comprising: receiving one or more common RACH configurations that are common for one or more UEs within the cell, the RACH configuration included in the one or more common RACH configurations; and identifying RACH resources associated with the RACH configuration based at least in part on the state of the UE with respect to the navigation satellite system.
Aspect 11: The method of aspect 10, wherein the one or more common RACH configurations indicate a common timing advance, a common frequency adjustment, or both, associated with the RACH procedure, the state of the UE with respect to the navigation satellite system comprises the UE being unable to obtain its location using the navigation satellite system, being incapable of using the navigation satellite system, or both, and the RACH signal is transmitted based at least in part on the common timing advance, the common frequency adjustment, or both.
Aspect 12: The method of any of aspects 10 through 11, wherein the state of the UE with respect to the navigation satellite system comprises the UE being able to obtain its location using the navigation satellite system, being capable of using the navigation satellite system, or both, the method further comprising: performing one or more measurements associated with the navigation satellite system to derive a UE-specific timing advance associated with the RACH procedure, a UE-specific frequency adjustment associated with the RACH procedure, or both based at least in part on the state of the UE with respect to the navigation satellite system, wherein the RACH signal is transmitted based at least in part on one or both of the UE-specific timing advance and the UE-specific frequency adjustment.
Aspect 13: The method of any of aspects 1 through 11, wherein the state of the UE with respect to the navigation satellite system comprises the UE being unable to obtain its location using the navigation satellite system, being incapable of using the navigation satellite system, or both, the method further comprising: receiving control signaling indicating a single second RACH configuration corresponding to the RACH triggering event; and deriving the RACH configuration from another RACH configuration that is different from the single second RACH configuration based at least in part on the state of the UE and one or more conditions associated with the single second RACH configuration.
Aspect 14: The method of any of aspects 1 through 4 and 7 through 12, wherein the state of the UE with respect to the navigation satellite system comprises the UE being able to obtain its location using the navigation satellite system, being capable of using the navigation satellite system, or both, and wherein the occurrence of the RACH triggering event comprises: receiving, based at least in part on the state of the UE with respect to the navigation satellite system, control signaling requesting that the UE perform the RACH procedure, the control signaling further indicating a second state with respect to the navigation satellite system, the second state the same as or different than the state of the UE with respect to the navigation satellite system, wherein the RACH configuration used for transmitting the RACH signal is based at least in part on the second state indicated by the control signaling.
Aspect 15: The method of aspect 14, wherein the control signaling requests that the UE performs the RACH procedure according to the RACH configuration for UEs that are unable to obtain their location using the navigation satellite system or are incapable of using the navigation satellite system, the method further comprising: deriving a timing advance of the RACH configuration used for transmitting the RACH signal, a frequency adjustment of the RACH configuration used for transmitting the RACH signal, or both from another RACH configuration that is unassociated with the navigation satellite system.
Aspect 16: A UE for wireless communication, comprising one or more memories storing processor-executable code, a transceiver, and one or more processors coupled with the one or more memories and the transceiver, the one or more processors individually or collectively operable to execute the code to cause the UE to perform a method of any of aspects 1 through 15.
Aspect 17: A UE for wireless communication, comprising at least one means for performing a method of any of aspects 1 through 15.
Aspect 18: A non-transitory computer-readable medium storing code for wireless communication, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors individually or collectively operable to execute the code to cause the UE to:
enter a connected mode associated with a non-terrestrial network entity based at least in part on being within a cell served by the non-terrestrial network entity;
determine to perform a random access procedure with the non-terrestrial network entity while in the connected mode based at least in part on an occurrence of a random access triggering event associated with the connected mode; and
transmit, via the transceiver and as part of the random access procedure, a random access signal based at least in part on a random access configuration and a state of the UE with respect to a navigation satellite system.

2. The UE of claim 1, wherein the state of the UE comprises whether the UE is able to obtain its location using the navigation satellite system, whether the UE is capable of using the navigation satellite system, or both.

3. The UE of claim 1, wherein the one or more processors are individually or collectively further operable to execute the code to cause the UE to:
receive, via the transceiver, control signaling indicating a plurality of random access configurations that corresponds to the random access triggering event, wherein the plurality of random access configurations comprises a first random access configuration for UEs in a first state with respect to the navigation satellite system and a second random access configuration for UEs in a second state with respect to the navigation satellite system.

4. The UE of claim 3, wherein the one or more processors are individually or collectively further operable to execute the code to cause the UE to:
select the random access configuration from among the plurality of random access configurations based at least in part on the state of the UE with respect to the navigation satellite system.

5. The UE of claim 1, wherein the state of the UE with respect to the navigation satellite system comprises the UE being unable to obtain its location using the navigation satellite system, being incapable of using the navigation satellite system, or both, and wherein the one or more processors are individually or collectively further operable to execute the code to cause the UE to:
receive, via the transceiver, control signaling indicating a single random access configuration that is for UEs in a first state with respect to the navigation satellite system, the first state comprising the UE being unable to obtain its location using the navigation satellite system or being incapable of using the navigation satellite system, wherein the random access configuration comprises the single random access configuration.

6. The UE of claim 1, wherein the state of the UE with respect to the navigation satellite system comprises the UE being unable to obtain its location using the navigation satellite system, being incapable of using the navigation satellite system, or both, and wherein the one or more processors are individually or collectively further operable to execute the code to cause the UE to:
receive, via the transceiver, first control signaling indicating an uplink timing advance, a frequency adjustment, or both, associated with the random access procedure; and
receive, via the transceiver, second control signaling indicating the random access configuration, wherein the random access configuration comprises random access resources for UEs that are able to obtain their location using the navigation satellite system or capable of using the navigation satellite system, and wherein the one or more processors are individually or collectively operable to execute the code to cause the UE to transmit the random access signal based at least in part on the random access resources and one or both of the uplink timing advance and the frequency adjustment.

7. The UE of claim 6, wherein at least one of the uplink timing advance or the frequency adjustment is common for one or more UEs within the cell.

8. The UE of claim 6, wherein at least one of the uplink timing advance or the frequency adjustment is dedicated to the UE.

9. The UE of claim 1, wherein the one or more processors are individually or collectively further operable to execute the code to cause the UE to:
transmit, via the transceiver, a capability report indicating that the UE supports random access configuration for UEs in a first state with respect to the navigation satellite system, that the UE supports random access configuration for UEs in a second state with respect to the navigation satellite system, or both; and
receive, via the transceiver, control signaling indicating one or more random access configurations based at least in part on the capability report, the one or more random access configurations comprising the random access configuration.

10. The UE of claim 1, wherein the one or more processors are individually or collectively further operable to execute the code to cause the UE to:
receive, via the transceiver, one or more common random access configurations that are common for one or more UEs within the cell, the random access configuration included in the one or more common random access configurations; and
identify random access resources associated with the random access configuration based at least in part on the state of the UE with respect to the navigation satellite system.

11. The UE of claim 10, wherein:
the one or more common random access configurations indicate a common timing advance, a common frequency adjustment, or both, associated with the random access procedure,
the state of the UE with respect to the navigation satellite system comprises the UE being unable to obtain its location using the navigation satellite system, being incapable of using the navigation satellite system, or both, and
the one or more processors are individually or collectively operable to execute the code to cause the UE to transmit the random access signal based at least in part on the common timing advance, the common frequency adjustment, or both.

12. The UE of claim 10, wherein the state of the UE with respect to the navigation satellite system comprises the UE being able to obtain its location using the navigation satellite system, being capable of using the navigation satellite system, or both, and wherein the one or more processors are individually or collectively further operable to execute the code to cause the UE to:
perform one or more measurements associated with the navigation satellite system to derive a UE-specific timing advance associated with the random access procedure, a UE-specific frequency adjustment associated with the random access procedure, or both based at least in part on the state of the UE with respect to the navigation satellite system, wherein the one or more processors are individually or collectively operable to execute the code to cause the UE to transmit the random access signal based at least in part on one or both of the UE-specific timing advance and the UE-specific frequency adjustment.

13. The UE of claim 1, wherein the state of the UE with respect to the navigation satellite system comprises the UE being unable to obtain its location using the navigation satellite system, being incapable of using the navigation satellite system, or both, and wherein the one or more processors are individually or collectively further operable to execute the code to cause the UE to:
receive, via the transceiver, control signaling indicating a single second random access configuration corresponding to the random access triggering event; and
derive the random access configuration from another random access configuration that is different from the single second random access configuration based at least in part on the state of the UE and one or more conditions associated with the single second random access configuration.

14. The UE of claim 1, wherein the state of the UE with respect to the navigation satellite system comprises the UE being able to obtain its location using the navigation satellite system, being capable of using the navigation satellite system, or both, and wherein the occurrence of the random access triggering event comprises:
receiving, via the transceiver and based at least in part on the state of the UE with respect to the navigation satellite system, control signaling requesting that the UE perform the random access procedure, the control signaling further indicating a second state with respect to the navigation satellite system, the second state the same as or different than the state of the UE with respect to the navigation satellite system, wherein the random access configuration used for transmitting the random access signal is based at least in part on the second state indicated by the control signaling.

15. The UE of claim 14, wherein the control signaling requests that the UE performs the random access procedure according to the random access configuration for UEs that are unable to obtain their location using the navigation satellite system or are incapable of using the navigation satellite system, and wherein the one or more processors are individually or collectively further operable to execute the code to cause the UE to:
derive a timing advance of the random access configuration used for transmitting the random access signal, a frequency adjustment of the random access configuration used for transmitting the random access signal, or both from another random access configuration that is unassociated with the navigation satellite system.

16. A method for wireless communication at a user equipment (UE), comprising:
entering a connected mode associated with a non-terrestrial network entity based at least in part on being within a cell served by the non-terrestrial network entity;
determining to perform a random access procedure with the non-terrestrial network entity while in the connected mode based at least in part on an occurrence of a random access triggering event associated with the connected mode; and
transmitting, as part of the random access procedure, a random access signal based at least in part on a random access configuration and a state of the UE with respect to a navigation satellite system.

17. The method of claim 16, wherein the state of the UE comprises whether the UE is able to obtain its location using the navigation satellite system, whether the UE is capable of using the navigation satellite system, or both.

18. The method of claim 16, further comprising:
receiving control signaling indicating a plurality of random access configurations that corresponds to the random access triggering event, wherein the plurality of random access configurations comprises a first random access configuration for UEs in a first state with respect to the navigation satellite system and a second random access configuration for UEs in a second state with respect to the navigation satellite system.

19. The method of claim 18, further comprising:
selecting the random access configuration from among the plurality of random access configurations based at least in part on the state of the UE with respect to the navigation satellite system.

20. A non-transitory computer-readable medium storing code for wireless communication, the code comprising instructions executable by one or more processors to:
enter a connected mode associated with a non-terrestrial network entity based at least in part on being within a cell served by the non-terrestrial network entity;
determine to perform a random access procedure with the non-terrestrial network entity while in the connected mode based at least in part on an occurrence of a random access triggering event associated with the connected mode; and
transmit, as part of the random access procedure, a random access signal based at least in part on a random access configuration and a state of a UE with respect to a navigation satellite system.
